(19) United States
(12) Patent Application Publication
(10) Pub. No.: US 2005/0151813 A1
(43) Pub. Date: Jul. 14, 2005

(54) Ink pack, ink cartridge and ink supplying device

(75) Inventor: Yoshiyuki Ikezaki, Nagoya-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 11/032,188

(22) Filed: Jan. 11, 2005

(30) Foreign Application Priority Data
Jan. 14, 2004 (JP) 2004-006816
Jan. 14, 2004 (JP) 2004-006817

(51) Int. Cl. B41J 2/195

(52) U.S. Cl. 347/86

(57) ABSTRACT

There is provided an ink pack, which is provided with an ink bag that accommodates ink, and a stopper attached to the ink bag to release the ink out of the ink bag. The ink pack is configured to satisfy a condition h/2≦H<2h, where H represents a height of a releasing position, at which the ink in the ink bag is released out of the stopper, with respect to a mounting surface on which the ink bag is placed, and h represents a size of the ink bag measured in a vertical direction when the ink bag in an initial state is placed on a horizontal surface.

### INCORPORATION BY REFERENCE

This application claims priority of Japanese Patent Applications No. 2004-006816, filed on Jan. 14, 2004, and No. 2004-006817, filed on Jan. 14, 2004, the entire subject matter of the applications is incorporated herein by reference thereto.

### BACKGROUND OF THE INVENTION

The present invention relates to an ink pack, an ink cartridge and an ink supplying device used for supplying ink to an printing device such as ink jet printing device.

In general, an ink supplying device for inkjet printing device is provided with an ink housing which accommodates ink cartridges (e.g. four ink cartridges for four color components), connection units to which the ink cartridges accommodated in the ink housing are connected, and tubes which supply ink from the connection units to inkjet heads. The ink cartridges are detachably attached to the ink housing so that the ink cartridges are replaced with new ones after the ink in the cartridges have run out.

Japanese Utility Model Publication No. 2591359 (hereafter, referred to as a document 1) discloses such an ink cartridge. FIG. 7 is a cross sectional view illustrating an ink cartridge 1 disclosed in the document 1. As shown in FIG. 7, the ink cartridge 1 includes an ink pack 4 and a box shape case 5 accommodating the ink pack 4. The ink pack 4 has a flexible ink bag 2 accommodating ink, and a stopper 3 from which the ink is outputted.

In the case 5, the ink bag 2 is placed on an inside bottom surface, and the stopper 3 is supported by a stopper holder Sa provided in a front wall of the case 5. A sensing member 6 is placed in the case 5 to contact the top surface of the ink bag 2 so that the sensing member 6 detects the remaining amount of ink in the ink bag 2.

In a situation in which the ink cartridge 1 is properly mounted on the ink housing, a hollow needle (not shown in FIG. 7) provided in the connection unit penetrates a rubber stopper provided at a front end of the stopper 3 to reach the inside of the stopper 3. By this structure, ink accommodated in the ink bag 2 is supplied to the tube through the hollow needle. The ink cartridge 1 is located at a position lower than nuzzles of an inkjet head so that the nozzles are kept at a negative pressure (i.e. a pressure lower than an atmosphere pressure).

The ink cartridge 1 has the sensing member 6 for detecting the amount of ink remaining in the ink bag 2. The sensing member 6 has a flat plate portion adhered to the top surface of the ink bag 2, and a pressing member which is integrally formed with the flat plate portion to be extended downwardly along both side portions of the ink bag 2.

As the ink bag 2 deflates with the decrease of the amount of ink in the ink bag 2, the flat plate portion of the sensing member 6 moves downwardly. As a result, the pressing member protrudes from a sensing window formed in the bottom wall of the case 2, and presses a switch (not shown in FIG. 7) to notify a time of replacement of the ink cartridge 1 to a user.

### SUMMARY OF THE INVENTION

The ink cartridge 1 disclosed in the document 1 is configured such that the stopper holder Sa provided in the front wall of the case 5 is located at a relatively low position. More specifically, a height h of the ink bag 2 is 20 mm when the ink bag 2 is full, and a height H0 (at which the hollow needle is positioned to penetrate the rubber stopper of the stopper 3) of the stopper 3 from the inside bottom surface of the case 5 is set to a value smaller than a half of the height h (e.g. H0=8 mm).

It is generally assumed that the reason why the stopper holder (i.e. the stopper 3) is located at a relatively low position is to enhance ink supply from the ink bag 2. However, the study made by the inventor of the present invention shows that the amount of ink remaining in the ink bag 2 at a time of replacement of the ink cartridge 1 becomes relatively large because the height H0 of the conventional ink cartridge 1 is relatively low.

It is preferable that the pressure variation in the nuzzle is small to keep the stability of ejection motion of the nozzle surface. The pressure variation of substantially zero is more preferable. By contrast, the ink pack 4 exhibits a phenomenon that a hydraulic head changes (decreases gradually) between an initial stage (at which the ink bag 2 is full) and a later stage (at which the ink in the ink bag 2 is decreased). Therefore, the pressure in the nozzle also changes with time.

The ink pack 4 is configured to be used within a predetermined range of the hydraulic head height (e.g. 0 through 30 mm). Since the conventional ink pack 4 is configured such that the changing amount of the height of the hydraulic head (i.e. the changing amount of the pressure in the nozzle) becomes larger as the amount of ink remaining in the ink bag 2 decreases, the amount of ink remaining in the ink bag 2 at the time of replacement of the ink cartridge 1 is relatively large. For example, the amount of ink remaining in the ink bag 2 at the time of replacement of the ink cartridge 1 is 25 g, while the amount of ink in the ink bag 2 in a initial state is 250 g.

Another factor that causes the relatively large amount of remaining ink at the time of replacement is that the ink tends to move to the rear side (the left side in FIG. 7) in the ink bag 2 because the front end of the ink bag 3 is lifted by the stopper 3. That is, a relatively large amount of ink remains in the rear side with respect to the flat portion of the ink bag 2 at the time of replacement.

The present invention is advantageous in that it provides an ink cartridge configured to reduce the amount of ink remaining in an ink bag at a time of replacement of the ink cartridge.

According to an aspect of the invention, there is provided an ink pack, which is provided with an ink bag that accommodates ink, and a stopper attached to the ink bag to release the ink out of the ink bag. The ink pack is configured to satisfy a condition:

$$\frac{h}{2} \leq H < 2 h$$

where H represents a height of a releasing position, at which the ink in the ink bag is released out of the stopper, with respect to a mounting surface on which the ink bag is placed, and h represents a size of the ink bag measured in a vertical direction when the ink bag in an initial state is placed on a horizontal surface.

With this configuration, the amount of ink remaining in the ink bag at a time of replacement of the ink pack can be reduced.

According to another aspect of the invention, there is provided an ink cartridge, which is provided with an ink pack that has an ink bag that accommodates ink, and a stopper attached to the ink bag to release the ink out of the ink bag. The ink cartridge is further provided with a case that accommodates the ink pack, the case having a mounting surface on which the ink bag is placed and a stopper holder that holds the stopper. The ink cartridge is configured to satisfy a condition:

$$\frac{h}{2} \leq H < 2 h$$

where H represents a height of a releasing position, at which the ink in the ink bag is released out of the stopper holder, with respect to the mounting surface, and h represents a size of the ink bag measured in a vertical direction when the ink bag in an initial state is placed on a horizontal surface.

With this configuration, the amount of ink remaining in the ink bag at a time of replacement of the ink cartridge can be reduced.

With regard to the above mentioned two aspects of the invention, a difference between values of H and h may be within a range of −10 mm through +10 nm.

With regard to the above mentioned two aspects of the invention, the ink bag may have flexibility.

Optionally, the ink cartridge may include a seating member provided in the case to lift a second portion of the ink bag opposed to a first portion to which the stopper is attached, and a detection member attached to a top surface of the ink bag at a portion which becomes a substantially horizontal surface when the ink bag becomes substantially empty of ink.

According to another aspect of the invention, there is provided an ink supplying device, which is provided with an ink housing to which an ink pack is detachably attached. The ink pack has an ink bag accommodating ink and has a stopper attached to the ink bag. The ink supplying device is further provided with a connection unit that is connected to the stopper of the ink pack to release the ink out of the ink bag through the stopper. The ink supplying device is configured to satisfy a condition:

$$\frac{h}{2} \leq H < 2 h$$

where H represents a height of a releasing position, at which the ink in the ink bag is released out of the connection unit, with respect to a mounting surface on which the ink bag is placed, and h represents a size of the ink bag measured in a vertical direction when the ink bag in an initial state is placed on a horizontal surface.

With this configuration, the amount of ink remaining in the ink bag at a time of replacement of the ink pack can be reduced.

According to another aspect of the invention, there is provided an ink supplying device, which is provided with an ink housing to which an ink cartridge is detachably attached. The ink cartridge has an ink pack and a case accommodating the ink pack. The ink pack has an ink bag accommodating ink and has a stopper attached to the ink bag. The ink supplying device is further provided with a connection unit that is connected to the stopper of the ink pack to release the ink out of the ink bag through the stopper. The ink supplying device is configured to satisfy a condition:

$$\frac{h}{2} \leq H < 2 h$$

where H represents a height of a releasing position, at which the ink in the ink bag is released out of the connection unit, with respect to a mounting surface on which the ink bag is placed, and h represents a size of the ink bag measured in a vertical direction when the ink bag in an initial state is placed on a horizontal surface.

With this configuration, the amount of ink remaining in the ink bag at a time of replacement of the ink cartridge can be reduced.

With regard to the above mentioned two aspects of the invention regarding the ink supplying devices, a difference between values of H and h may be within a range of −10 mm through +10 mm.

According to another aspect of the invention, there s provided an ink cartridge, which is provided with an ink bag that accommodates ink, a stopper attached to a first portion of the ink bag to release the ink out of the ink bag, a case that accommodates the ink bag, a seating member provided in the case to lift a second portion of the ink bag opposed to the first portion, and a detection member attached to a top surface of the ink bag at a portion which becomes a substantially horizontal surface when the ink bag becomes substantially empty of ink.

With this configuration, the amount of ink remaining in the ink bag at a time of replacement of the ink cartridge can be reduced. It becomes possible to accurately detect the remaining amount of the ink in the ink bag.

Optionally, the ink bag may have a rectangular shape. In this case, the stopper is attached to one of shorter sides of the ink bag, and the seating member is located in a portion opposed to the one of the shorter sides of the ink bag with respect to a center position along a longer side of the ink bag.

Still optionally, the seating member may have a shape elongated in a direction of a shorter side of the ink bag.

Still optionally, the seating member may be elongated in the direction of the shorter side of the ink bag across an effective size of the ink bag in the direction of the shorter side.

Still optionally, the seating member may lift the ink bag so that the substantially horizontal surface formed when the ink bag becomes substantially empty of ink is situated on a stopper side with respect to a center position along a direction of a longer side of the ink bag, and the detection member may be located on the stopper side with respect to the center position along the direction of the longer side of the ink bag.

In a particular case, the seating member may be fixed to an inner bottom surface of the case.

Optionally, the detection member may be made from paper.

Still optionally, the detection member may have a shape elongated in a direction of a shorter side of the ink bag.

Still optionally, the detection member may be elongated in the direction of the shorter side of the ink bag across an effective size of the ink bag in the direction of the shorter side.

In a particular case, the case having a mounting surface on which the ink bag may be placed and a stopper holder that holds the stopper, and the ink cartridge is configured to satisfy a condition:

$$\frac{h}{2} \leq H < 2 h$$

where H represents a height of a releasing position, at which the ink in the ink bag is released out of the stopper holder, with respect to the mounting surface, and h represents a size of the ink bag measured in a vertical direction when the ink bag in an initial state is placed on a horizontal surface.

According to another aspect of the invention, there is provided a sensing system for sensing a remaining amount of ink, which is provided with an ink bag that accommodates ink, a stopper attached to a first portion of the ink bag to release the ink out of the ink bag, a case that accommodates the ink bag, a housing in which the case is set, a seating member provided in the case to lift a second portion of the ink bag opposed to the first portion, and a sensing member that is movably attached to the housing and has a plate-like member, the plate-like member contacting a top surface of the ink bag at a portion which becomes a substantially horizontal surface when the ink bag becomes substantially empty of ink.

With this configuration, the amount of ink remaining in the ink bag at a time of replacement of the ink cartridge can be reduced. It becomes possible to accurately detect the remaining amount of the ink in the ink bag.

According to another aspect of the invention, there is provided a sensing system for sensing a remaining amount of ink, which is provided with an ink bag that accommodates ink, a stopper attached to a first portion of the ink bag to release the ink out of the ink bag, a case that accommodates the ink bag, a housing in which the case is set, and a seating member provided in the case to lift a second portion of the ink bag opposed to the first portion. The sensing system further provided with a detection member attached to a top surface of the ink bag at a portion which becomes a substantially horizontal surface when the ink bag becomes substantially empty of ink, and a sensing member that is movably attached to the housing so that a tip portion of the sensing member contacts the detection member.

With this configuration, the amount of ink remaining in the ink bag at a time of replacement of the ink cartridge can be reduced. It becomes possible to accurately detect the remaining amount of the ink in the ink bag.

### BRIEF DESCRIPTION OF THE ACCOMPANYING DRAWINGS

FIG. 1A is a cross sectional view of an ink cartridge according to a first embodiment illustrated as a side view;

FIG. 1B is a cross sectional view of the ink cartridge illustrated as a top view;

FIG. 1C is a cross sectional view of the ink cartridge illustrated as a front view;

FIG. 2 is a cross sectional view of the ink cartridge and an ink supplying device illustrating a situation in which the ink cartridge is attached to a connection unit;

FIG. 3 illustrates a situation of an experiment;

FIG. 4 is a graph illustrating a change of a hydraulic head with respect to the amount of ink remaining in an ink pack;

FIG. 5A schematically shows a positional relationship between an ink bag and a nozzle;

FIG. 5B is an enlarged view of the nozzle of FIG. 5A;

FIG. 6 is a perspective view of a main body of an inkjet printing device to which the present invention is applied;

FIG. 7 is a cross sectional view of a conventional ink cartridge;

FIG. 8 is a perspective view of a main body of an inkjet printing device to which the present invention is applied;

FIG. 9 is a cross sectional view of an ink housing illustrated as a side view to show an initial state of an ink cartridge;

FIG. 10 is a cross sectional views of the ink housing illustrated as a side view to show a low ink state of the ink cartridge;

FIG. 11 is a top view of the ink housing illustrating a situation in which the ink cartridge is attached to the ink housing;

FIG. 12A is a cross sectional view of an ink pack illustrated as a side view;

FIG. 12B is a cross sectional view of the ink pack illustrated as a top view;

FIG. 12C is a cross sectional view of the ink pack illustrated as a front view; and

FIG. 13 shows another example of a configuration of an ink supplying unit according to the invention.

### DETAILED DESCRIPTION OF THE EMBODIMENTS

Hereafter, embodiments according to the invention will be described with reference to the accompanying drawings.

### First Embodiment

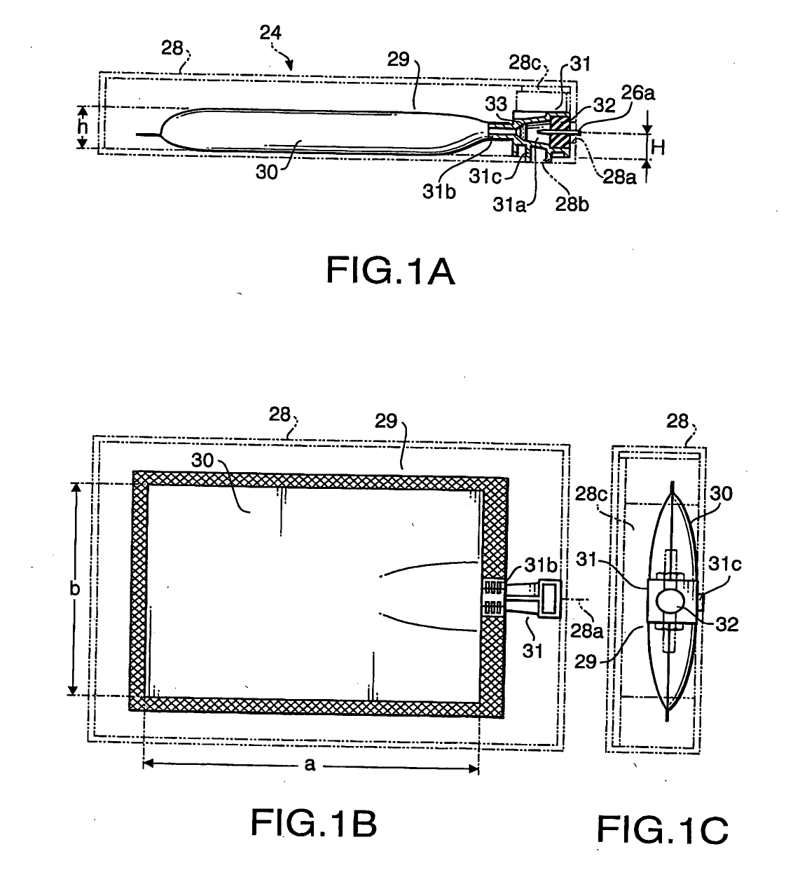

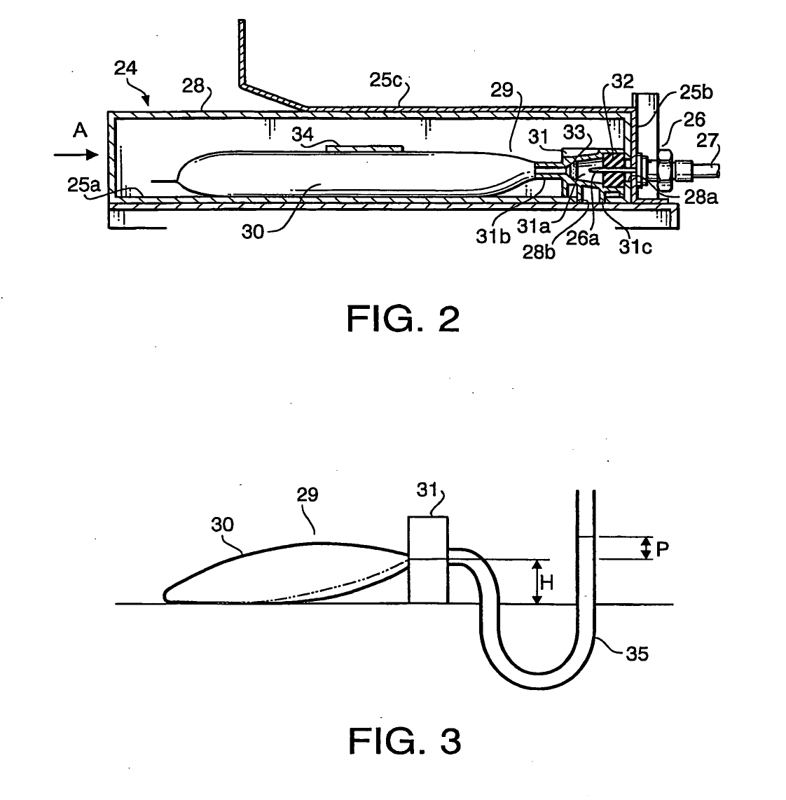

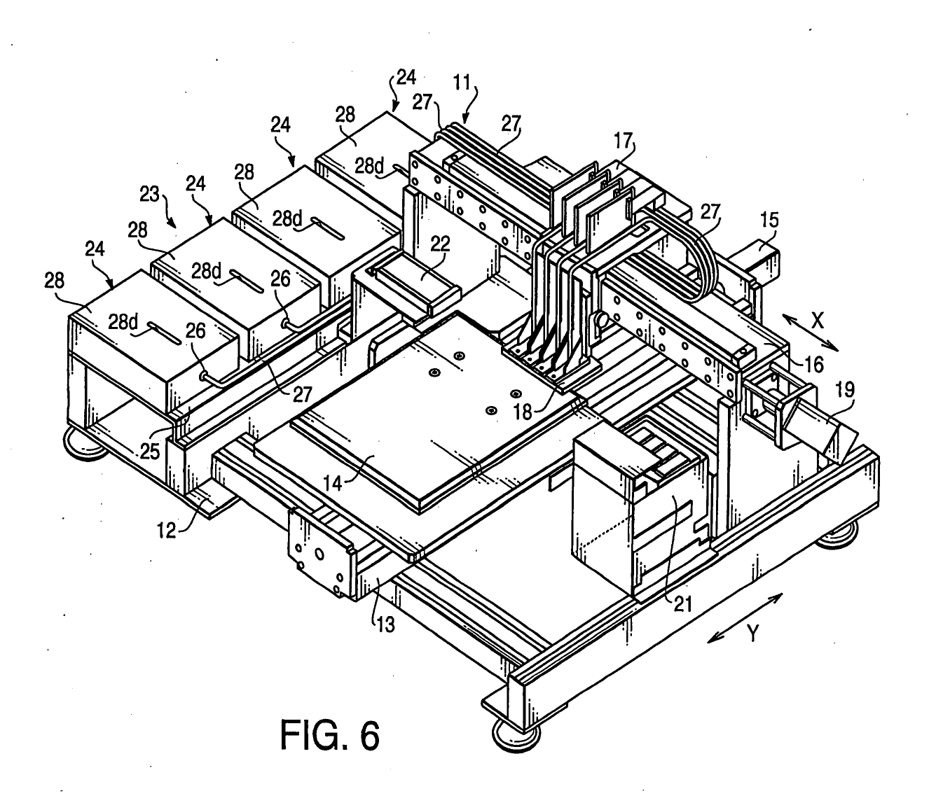

Firstly, a general configuration of an ink jet printing device will be explained with reference to FIG. 6 which is a perspective view of a main body 11 of the inkjet printing device to which the present invention is applied. FIG. 1A is a cross sectional view of an ink cartridge 24 illustrated as a side view, FIG. 1B is a cross sectional view of the ink cartridge 24 illustrated as a top view, and FIG. 1C is a cross sectional view of the ink cartridge 24 illustrated as a front view. FIG. 2 is a cross sectional view of the ink cartridge 24 and an ink supplying device 23 illustrating a situation in which the ink cartridge 24 is attached to a connection unit 26.

The inkjet printing device is configured to form an image (designs, etc.) onto fabric such as a T-shirt. As shown in FIG. 6, the main body 11 includes a frame 12 having a rectangular shape. A y-axis rail 13 is mounted above the frame 12 to be extended, in the center of the fame 12, in a back-and-forth direction (i.e. Y-direction). Hereafter, the Y-direction is frequently referred to as an auxiliary scanning direction.

A platen 14 is slidably supported by the y-axis rail 13 in the Y-direction. The main body 11 has a platen motor 15 and a platen driving mechanism (not shown) so that the platen 14 is driven in the Y-direction.

An x-axis rail 16 is located, on the rear side of the frame 12, at a position higher than the platen 14 to be extended in a X-direction which is perpendicular to the Y-direction. Hereafter, the X-direction is frequently referred to as a main scanning direction. A printing carriage 17 is slidably supported by the x-axis rail 16 in the X-direction. A printing head 18 is located on the lower side of the printing carriage 17. The main body 11 has a carriage moving mechanism including a carriage motor 19 and a belt transmission mechanism for moving the printing carriage 17 in the X-direction.

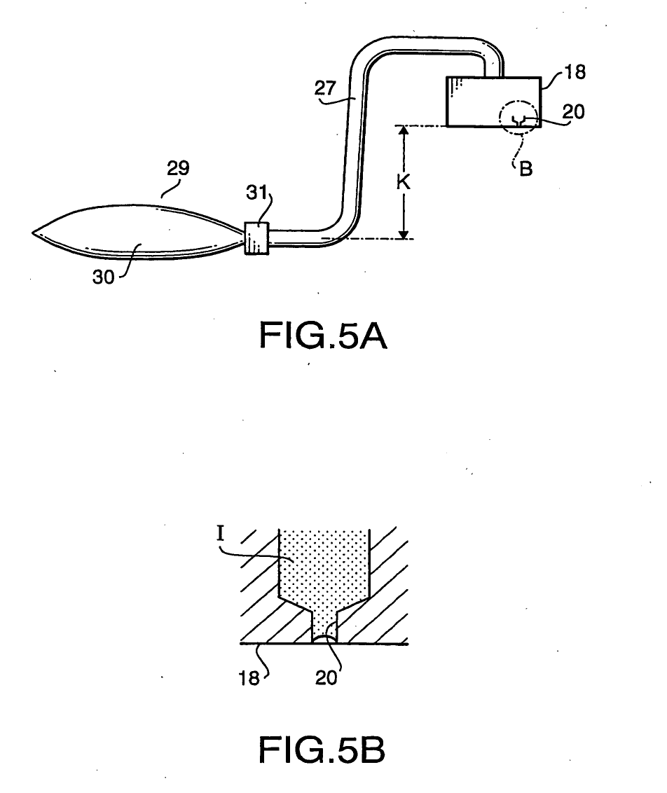

The printing head 18 is provided with four ejecting portions, each of which has a plurality of nozzles on the bottom surface thereof (see FIGS. 5A and 5B). To the four ejecting portions, four types of ink I corresponding to four color components of cyan, yellow, magenta and black are supplied from the ink supplying device 23. The printing head 18 has pressure chambers and piezoelectric devices for ejecting downwardly ink from each nozzle on a substrate loaded onto the platen 14.

On the right side of the main body 11, an ejection restoring mechanism 21 is mounted on the frame 12. On the left side of the main body 11, an ink tray 22 is located to catch the ink ejected by the nozzles. The ejection restoring mechanism 21 is configured to remove ink I, dust, air bubbles and etc. in the nozzles by conducting a sucking operation on the bottom surface of the printing head 18.

The inkjet printing device is configured to eject ink from the printing head 18, for example, at regular time intervals, so as to prevent the ink I in the nozzle from increasing its viscosity due to drying. The ink tray 22 catches the ink ejected by the nozzle when such an operation for preventing drying of the ink in the nozzle is conducted.

The inkjet printing device has a control unit (not shown) including a CPU (central processing unit) which controls various types of mechanisms provided in the main body 11. Under control of the control unit, a color image (designs and etc.) is properly printed on the substrate loaded on the platen 14.

The ink supplying device 23 is located on the left side of the frame 12. The ink supplying device 23 is provided with an ink housing 25 in which four ink cartridges 24 are aligned in the back-and-forth direction. The ink cartridges 24 are detachably attached to the ink housing 25. The ink supplying device 23 is further provided with four connection units 26 to which the ink cartridges 24 are detachably attached.

The ink supplying device 23 is further provided with four flexible tubes 27 which connect the connection units 26 to the printing head 18 (printing carriage 17) for supplying ink.

As shown in FIG. 2, the ink housing 25 has a mounting base 25a on which the ink cartridge 24 is placed, a stopper plate 25b to which the front (right side) wall of the ink cartridge 24 contacts, and an upper plate 25c extending form the top of the stopper plate 25b in a horizontal direction to support the top surface of the cartridge 24. The mounting base 25a is configured to be a horizontal surface. The ink housing 25 is further provided with guide plates (not shown) to support both of the longer side surfaces of the ink cartridge 24.

That is, the ink housing 25 has an opened section on the left side (on FIG. 2) thereof. The ink cartridge 24 is set in the ink housing 25 by inserting the ink cartridge 24 from the opened side (left side) toward the front side (right side) of the ink housing 25 as indicated by an arrow A in FIG. 2. The ink cartridge 24 can be detached from the ink housing 25 by pulling out the ink cartridge 24 in a direction opposite to the direction A (the arrow A).

The connection unit 26 is provided with a hollow needle 26a protruding through the stopper plate 25b toward the inside (the left side in FIG. 2) of the ink housing 25. By inserting the hollow needle 26a into the inside of a stopper 31, the ink is released form the ink cartridge 24 to the tube 27.

Next, the configuration of the ink cartridge 24 will be explained in detail. As shown in FIGS. 1A, 1B, 1C and 2, the ink cartridge 24 has a case 28 having a form of a box, and an ink pack 29 accommodated in the case 28. The case 28 is formed, for example, from cardboard. The ink pack 29 includes a flexible ink bag 30 accommodating the ink, and the stopper 31 from which the ink is outputted.

The ink bag 31 is formed by lapping a flexible transparent plastic sheet over another, and sealing off them by heat at the periphery thereof. That is, the ink bag 31 is formed to be a flat bag. The plastic film consisting the ink bag 31 is formed, for example, from a laminated structure of polyethylene, nylon, and PET (polyethylene terephthalate) on which silica is deposited, which are laminated in that order from the inside of the ink bag. For example, the polyethylene, nylon and PET may have the thicknesses of 40 μm, 15 μm and 12 μm, respectively.

For example, the ink bag 30 has an effective size of 150 mm along the longer side (i.e. a size “a” shown in FIG. 1B) and 112 mm along the shorter side (i.e. a size “b” shown in FIG. 1B). For example, the sealing width (indicated by a hatching pattern in FIG. 1B) is 10 mm at the front side, and is 6 mm at the other sides. The ink bag 30 is configured to accommodate the ink I of 250 g at an initial stage. For example, the ink I has a relative density of approximately 1.1.

The stopper 31 is formed, for example, from molded resin such as PE (polyethylene) and PP (polypropylene). The stopper 31 is provided with a base part having a hollow 31a, and a connection part 31b which is integrally formed with the base part to be extended from the base part toward the left side (in FIG. 2). The base part of the stopper 31 is configured to have a cylindrical-shaped portion and a tip portion (the right side end in FIG. 2) having a box shape of which outer shape is larger than that of the cylindrical-shaped portion.

The hollow 31a is formed to be a tapered shape so as to have a circular opening at the tip portion. The circular opening of the stopper 31 is sealed by a rubber stopper 32 having a thin cylindrical shape. In the hollow 31a, a filter 33 is located on the opposite side of the circular opening. A positioning projection 31c is integrally formed on the bottom surface of the base part of the stopper 31.

The connection part 31b has a flat shape and is configured to have a communication hole that connects the inside of the ink bag 30 to the hollow 31a. The communication hole is extended in the left and right direction in FIG. 2. The connection part 31b is fixed at the center of one of shorter sides of the ink bag 30 such that the connection part 31b is closely sandwiched between the two plastic films. By this structure, the ink bag 30 is hermetically sealed, and the ink in the ink bag 30 is supplied from the inside of the ink bag 31 to the hollow 31a in the stopper 31 through the filer 33.

The case 28 accommodating the ink pack 29 is configured to have a box shape having a size larger than the ink pack 29. The case 28 has a front wall having an opening 28a formed in the center of the front wall. In the bottom surface of the case 28, a positioning hole 28b having a rectangular shape is formed at the front end portion of the bottom surface. The ink pack 29 is positioned in the case 28 by fitting the positioning projection 31c into the positioning hole 28b. Therefore, the front end of the stopper 31 faces the opening 28a formed in the front wall of the case 28.

The case 28 is further provided with a holder 28c (see FIGS. 1A and 1C) which is located at the front end in the case 28. The holder 2& is integrally formed with the case 28 so as to press the stopper 31 from the upper side and to support the tip portion of the stopper 31 from the rear side. That is, the stopper 31 is supported not to move to the upper side and to the rear side (the left side in FIG. 2), with the ink bag 30 being placed on the bottom surface of the case 28.

By this structure, the stopper 31 is held by a stopper holding unit (including the positioning hole 28b and the holder 28c) located at the front end of the case 28, with the front surface of the stopper 31 facing the opening 28a. The case 28 is mounted so that the inner bottom surface on which the ink bag 30 is placed is a horizontal surface.

A slit-like hole 28d is formed in the upper wall of the case 28 (see FIG. 6) so that a tip portion of a sensing lever (not shown) for sensing the amount of ink remaining in the ink bag 30 is inserted through the slit-like hole 28 to touch a detection plate 34 adhered to the center position on the top surface of the ink bag 30. The detection plate 34 may be formed, for example, from cardboard.

The case 28 may be formed from a sheet of cardboard which is cut to have a certain shape and is formed to have creases and openings so that the holder 28c can be formed by folding a front end portion (continuously formed at the front side of the case 28) a plurality of times inwardly.

By setting the ink cartridge 24 in the ink housing 25, the hollow needle 26 penetrates the center of the rubber stopper 32 through the opening 28a to reach the hollow 31a of the stopper 31. Thus, the ink in the ink bag 30 is supplied to the printing head 18 through the stopper 31, the connection unit 26 and the tube 27.

FIG. 5A schematically shows a positional relationship between the ink bag 30 and the nozzle 20, and FIG. 5B is an enlarged view of a circled portion B (i.e. the nozzle 20) of FIG. 5A. As shown in FIGS. 5A and 5B, the ink bag 30 of the ink cartridge 24 is located at a position lower than a position of the nozzle 20 of the printing head 18 so that the inside of the nozzle 20 is constantly kept at a negative pressure (i.e. a pressure lower than an atmosphere pressure). The height K of the nozzle 20 from the hollow needle 26a is, for example, 40 mm.

In this embodiment, as shown in FIG. 1A, the height H of an ink releasing position of the stopper 31 from the bottom surface of the stopper 31 (except the positioning projection 31c) is smaller than two times the height h (the size of the ink bag 30 in the vertical direction) and is larger than or equal to a half of the height h. That is, the following condition is satisfied.

$$\frac{h}{2} \leq H < 2 h$$

The height of the ink releasing position of the stopper holding unit from a mounting surface for the ink bag 30 (the inside bottom surface of the case 2) is also represented as the height H. Also, the height of the hollow needle 26a of the connection unit 26 from the mounting surface for the ink bag 30 (the inside bottom surface of the case 2) is represented as the height H.

For example, the height h of the ink bag 30 is approximately 20 mm (18 through 22 mm), and the height H of the ink releasing position is smaller than 40 mm and larger than or equal to 10 mm. In this embodiment, the height H is 18 mm.

Next, the detailed operation of the ink supplying device 23 will be explained with reference to FIGS. 3 to 5. At an initial state of use of the ink cartridge 24, the ink pack 29 (i.e. the ink bag 30) of each ink cartridge 24 accommodates 250 grams of ink. By setting the ink cartridge 24 in the connection unit 26, the ink in the ink bag 30 is supplied to the printing head 18 through the tube 27 so that pressure chambers (not shown) and the nozzles 20 in the printing head 18 are filled with the ink I.

Since the printing head 18 is located at the position higher than the position of the ink housing 25 as shown in FIGS. 5A and 5B, the inside of the nozzle 20 is kept at the negative pressure, and thereby a front end surface of the ink I in the nozzle 20 takes a concave shape recessed toward the inside of (the upper side in FIGS. 5A and 5B) the nozzle 20. It is understood that if the inside of the nozzle 20 is at a positive pressure, leakage of the ink I from the nozzle 20 is caused.

Since the front end surface of the ink I in the nozzle 20 has the concave shape (a meniscus shape), a stable ink ejecting operation of the nozzle 20 is maintained. As the ink in the nozzle 20 is ejected (consumed) by a printing operation, the nozzle 20 is refilled with the ink supplied from the ink pack 29.

As the amount of the ink in the ink pack 29 decreases by the printing operation, the ink bag 30 deflates gradually and thereby the position of the detection plate 34 is lowered. If the position of the sensing lever is lowered to a predetermined position with the decrease of the amount of ink in the ink bag 30, notification (e.g. indication on an operation panel, alarm sound, etc.) prompting a user to replace the ink cartridge 24 with new one is given to the user by the control unit. After the user is notified of the replacement time of the ink cartridge 24, the user replaces the ink cartridge 24 with new one.

It is possible to judge whether the ink cartridge 24 (the ink pack 29) can be used or not based on the height of the hydraulic head. That is, the time of replacement of the ink cartridge 24 can be determined based on the height of the hydraulic head. It is preferable that the variation of pressure in the nozzle 20 is small to keep the stability of ejection operation of the nozzle surface. The pressure variation of substantially zero is more preferable.

As the height of the hydraulic head changes (decrease gradually) between an initial state (in which the ink bag 30 is full) and a low ink state, the pressure in the nozzle 20 also changes. For this reason, the ink pack 29 is used within a predetermined range of the hydraulic head height (e.g. 0 through 30 mm).

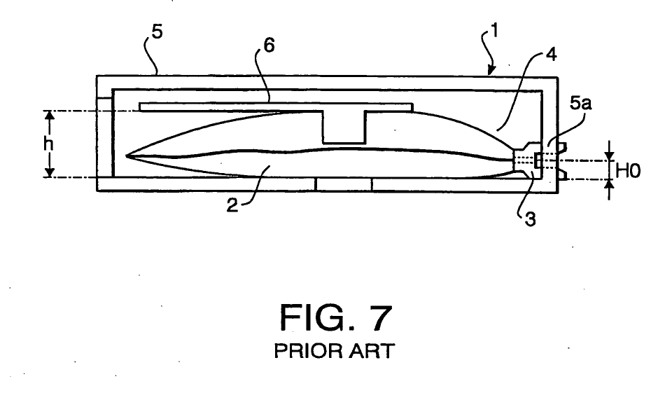

By contrast, as described above with reference to FIG. 7, the conventional ink cartridge 1 is configured such that the height H0 of an ink releasing position of the stopper 3 from the inside bottom surface of the case 5 is relatively low. In such a configuration of the conventional ink cartridge 1, it is required to replace the ink cartridge 1 in a state in which a relatively large amount of ink is left in the ink bag 2. For example, the amount of ink remaining in the ink bag 2 at the replacement time of the cartridge 1 is 25 g, while the initial amount of ink in the ink bag 2 is 250 g.

However, in this embodiment, the height H0 of the ink releasing position of the stopper 31 from the mounting surface of the ink pack 29 is set higher than that of the conventional ink cartridge. Therefore, the pressure variation in the nozzle 20 (i.e. the change of the hydraulic height) becomes smaller than that of the conventional ink cartridge 1, by which the amount of ink remaining in the ink bag 30 at the time of replacement can be reduced. In this embodiment, the stable ink ejecting operation can be maintained until the amount of ink remaining in the ink bag 30 decreases to 15 grams.

Conventionally, it is generally assumed that by locating the stopper 3 at the relatively low position, ink supply from the ink bag 2 can be enhanced However, the study made by the inventor shows that the amount of ink remaining in the ink bag 30 at the time of replacement of the ink cartridge 24 can be reduced by locating the ink releasing position of the stopper 31 at a relatively high position. By locating the ink releasing position of the stopper 31 at the relatively high position, the change of the hydraulic head is kept at a low level even if the amount of ink remaining in the ink bag 30 decreases.

Therefore, according to the embodiment, the amount of ink remaining in the ink pack 29 at the time of replacement of the ink pack 29 (ink cartridge 24) can be reduced.

The study of the inventor also revealed that if the height of the ink releasing position of the stopper 31 is excessively large, the change of the hydraulic head becomes large. According to the study of the inventor, in this embodiment, the height H of the ink releasing position of the stopper 31 from the mounting surface of the stopper 31 is set to have a value smaller than two times the height h (the size of the ink bag 30 in the vertical direction) and larger than or equal to a half of the height h.

The study of the inventor also revealed that it is preferable that a difference between the height H of the ink releasing position of the stopper 31 and the height b of the ink bag 30 is within ±10 mm.

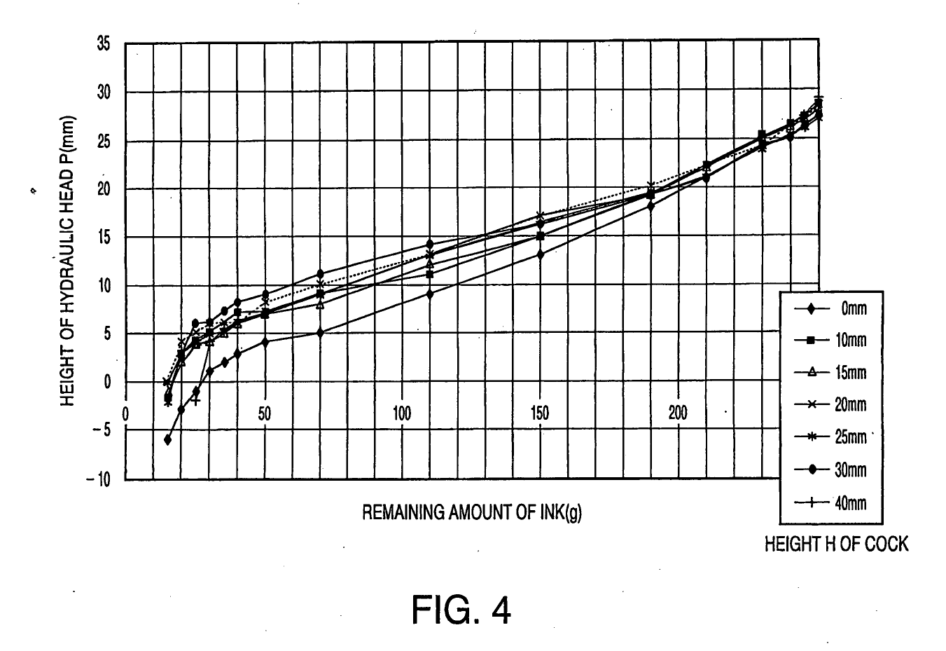

FIG. 4 represents experimental results according to the study of the inventor. FIG. 4 illustrates the change of the hydraulic head with respect to the amount of ink remaining in the ink pack 29. In FIG. 4, a plurality of curves are indicated with regard to different heights H. FIG. 3 illustrates a situation of the experiment. The ink pack 29 is placed on a horizontal mounting surface, and the stopper 31 is connected to one end of a tube 35 having a form of a letter U.

In the experiment, the height of the hydraulic head is defined as a height P of a liquid column in the tube 35. The height P is plotted by changing the amount of remaining ink from 25 grams to about zero gram with regard to the various types of heights H (i.e. the height of the center of the rubber stopper 32 from the mounting surface of the stopper 31) of 0 mm, 10 mm, 15 mm, 20 mm, 25 mm, 30 mm and 40 mm. The height P is measured with respect to the ink releasing position of the stopper 31. In an initial state, the height h of the ink bag 30 with respect to the mounting surface of the ink bag 30 is 20 mm.

As shown in FIG. 4, in the case of the height H is 0 mm, the height of the hydraulic head becomes 0 mm at the amount of remaining ink of about 25 grams. In the case of the height H is 40 mm, the height of the hydraulic head becomes 0 mm at the amount of remaining ink of about 25 grams. By contrast, with regard to the height H within 10 mm through 30 mm, the height of the hydraulic head becomes 0 mm at the amount of remaining ink of about 15 grams.

It is understood by this experimental results that the ink pack 29 can be used until the amount of remaining ink decreases to 15 grams, assuming that the stable ejecting operation can be attained within a range of the height P of 0 mm through 30 mm. Therefore, according to the embodiment, 10 grams of ink can be additionally used in comparison with the conventional ink cartridge.

By setting the height H of the ink releasing position of the stopper 31 from the mounting surface of the stopper 31 to a value smaller than two times the height h (the size of the ink bag 30 in the vertical direction) and larger than or equal to a half of the height h, the change of the hydraulic head can be reduced, and therefore the amount of ink remaining in the ink bag 30 at the time of replacement of the ink pack 29 (the ink cartridge 24) can be reduced.

It should be noted that if the amount of ink in the ink bag 30 in the initial state is larger than 250 grams, the height of the hydraulic head exceeds 30 mm. Therefore, the amount of ink larger than 250 grams in the initial state is not suitable for use in the inkjet printing device.

As described above, according to the configurations of the ink pack 29, the ink cartridge 24 and the ink supplying device 23, the amount of ink remaining in the ink bag 30 at the time of replacement of the ink pack 29 (the ink cartridge 24) can be reduced.

Although in the above mentioned embodiment the ink bag 30 having the height h of 20 mm is used by way of example, the present invention can also be applied to various types of ink bags having different material, different sizes or different amounts of ink. That is, the present invention can also be applied to ink bags having different heights h. Even if the ink bag having different height h is used, the above mentioned advantage can also be attained by setting the height H of the ink releasing position of the stopper from the mounting surface of the stopper to a value smaller than two times the height h (the size of the ink bag in the vertical direction) and larger than or equal to a half of the height h. A gazette bag may used as the ink bag. Also, various types of stoppers having different outer shapes and inner structures can be employed.

In the above mentioned embodiment, the case 28 is formed from a sheet of cardboard. However, various types of material (e.g. plastic) may be used to form the case 28. Also, the case 28 may have a different structure.

In the above mentioned embodiment, the ink cartridge 24 is detachably attached to the ink housing 25. However, the ink pack 29 may be configured to be directly attached to the ink housing (or the connection unit 26). Various types of connecting structures can be employed as the connection unit 26.

### Second Embodiment

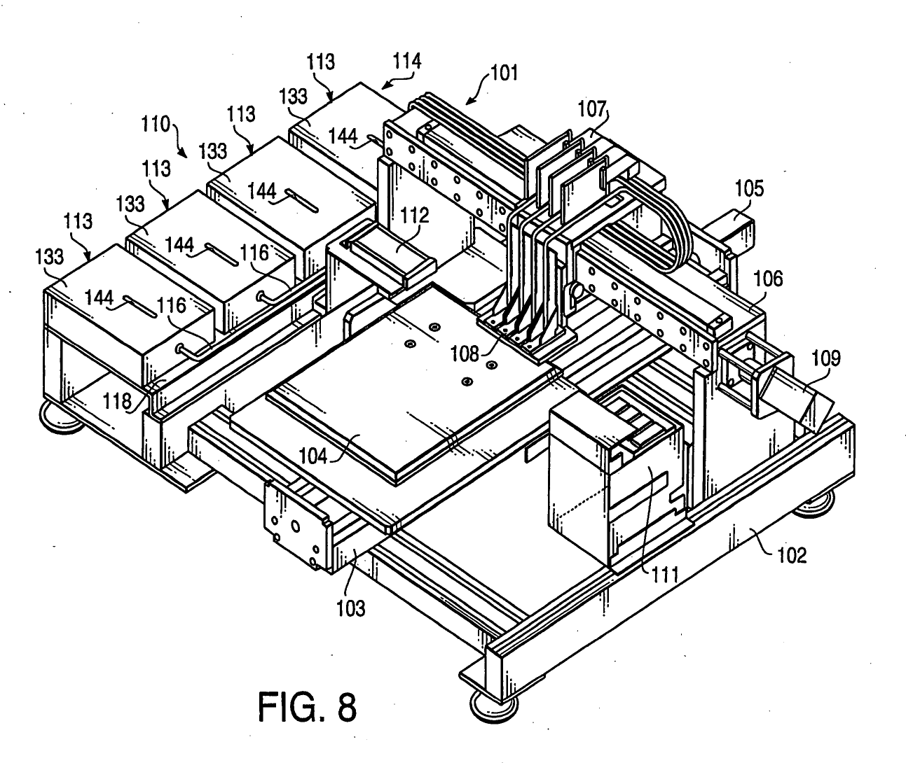

Hereafter, a second embodiment of the invention will be explained. FIG. 8 is a perspective view of a main body 101 of an inkjet printing device to which the present invention is applied. The inkjet printing device is configured to form an image (or designs) onto fabric such as a T-shirt. As shown in FIG. 8, the main body 101 includes a frame 102 having a rectangular shape. A y-axis rail 103 is mounted above the frame 102 to be extended, in the center of the frame 102, in a back-and-forth direction (i.e. Y-direction). Hereafter, the Y-direction is frequently referred to as an auxiliary scanning direction.

A platen 104 is slidably supported by the y-axis rail 103 in the Y-direction. The main body 101 has a platen motor 105 and a platen driving mechanism (not shown) so that the platen 104 is driven in the Y-direction.

A x-axis rail 106 is located, on the rear side of the frame 102, at a position higher than the platen 104 to be extended in a X-direction which is perpendicular to the Y-direction. Hereafter, the X-direction is frequently referred to as a main scanning direction. A printing carriage 107 is slidably supported by the x-axis rail 106 in the X-direction. A printing head 108 is located on the lower side of the printing carriage 107. The main body 101 has a carriage moving mechanism including a carriage motor 109 and a belt transmission mechanism for moving the printing carriage 107 in the X-direction.

The printing head 108 is provided with four ejecting portions, each of which has a plurality of nozzles on the bottom surface thereof. To the four ejecting portions, four types of ink corresponding to four color components of cyan, yellow magenta and black are supplied from an ink supplying device 110. The printing head 108 has pressure chambers and piezoelectric devices for ejecting downwardly ink from each nozzle on a substrate loaded onto the platen 104.

On the right side of the main body 101, an ejection restoring mechanism 111 is mounted on the frame 102. On the left side of the main body 101, an ink tray 112 is located to catch the ink ejected by the nozzles. The ejection restoring mechanism 111 is configured to remove ink, dust, air bubbles and etc. in the nozzles by conducting a sucking operation on the bottom surface of the printing head 108.

The inkjet printing device is configured to eject ink from the printing head 108, for example, at regular time intervals, so as to prevent the ink in the nozzle from increasing its viscosity due to drying. The ink tray 112 catches the ink ejected by the nozzle when such an operation for the prevention of drying is conducted.

The inkjet printing device has a control unit (not shown) including a CPU (central processing unit) which controls various types of mechanisms provided in the main body 101. Under control of the control unit, a color image (designs and etc.) is properly printed on the substrate loaded on the platen 104.

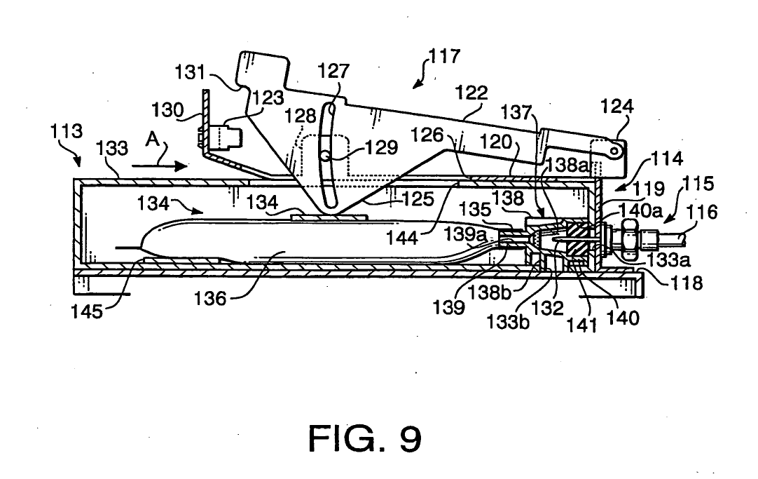

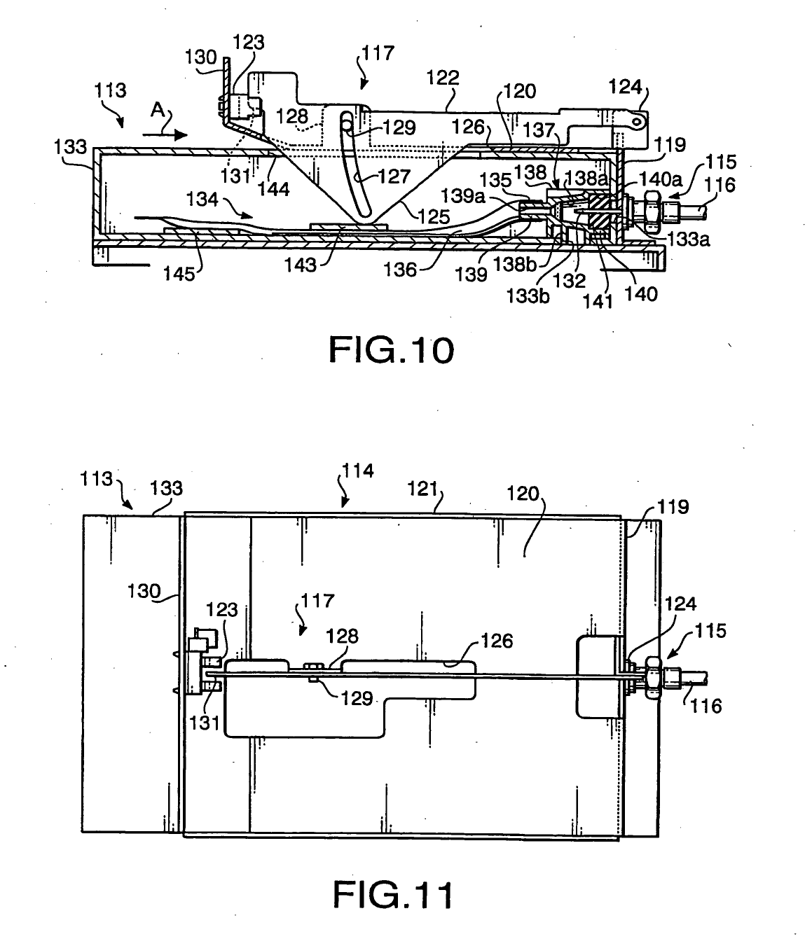

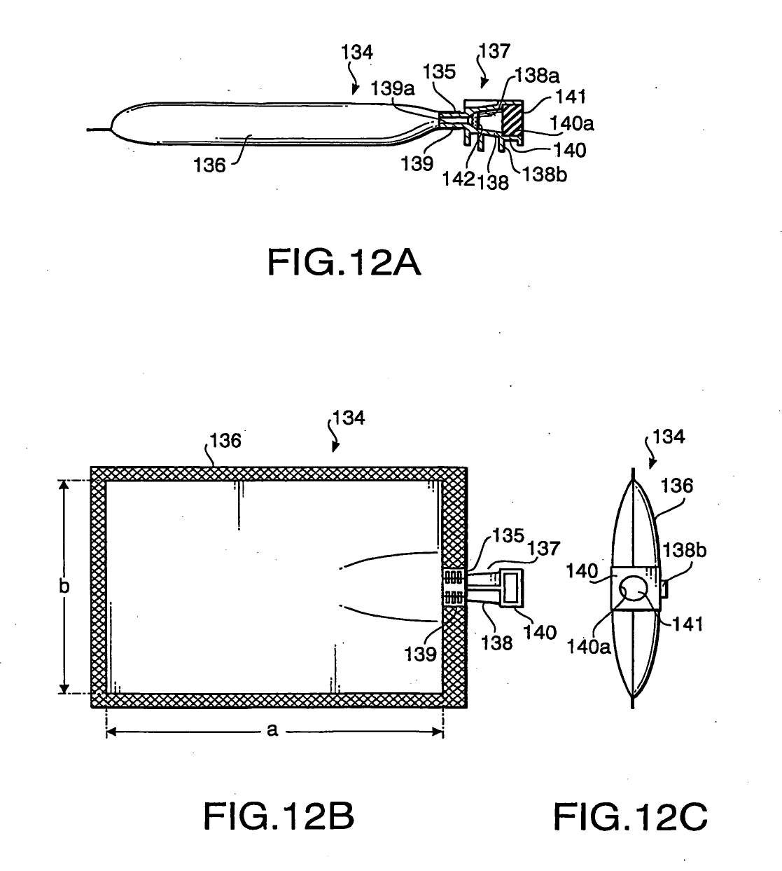

Next, the ink supplying device 110 according to the second embodiment will be explained in detail with reference to FIGS. 8 through 12C. FIGS. 9 and 10 are cross sectional views of an ink housing 114 illustrated as a side view. FIG. 9 illustrates an initial state of an ink cartridge 113. FIG. 10 illustrates a low ink state (i.e. the replacement time) of the ink cartridge 113. FIG. 11 is a top view of the ink housing 114 illustrating a situation in which the ink cartridge 113 has been attached to the ink housing. FIG. 12A is a cross sectional view of an ink pack 134 illustrated as a side view, FIG. 12B is a cross sectional view of the ink pack 134 illustrated as a top view, and FIG. 12C is a cross sectional view of the ink pack 134 illustrated as a front view.

The ink supplying device 110 is located on the left side of the frame 102. The ink supplying device 110 is provided with the ink housing 114 in which four ink cartridges 113 are aligned in the back-and-forth direction. The ink cartridges 113 are detachably attached to the ink housing 114.

The ink supplying device 110 is further provided with four connection units 115 which are detachably attached to the ink cartridges 113 when the ink cartridges 113 are properly set in the ink housing 114. The ink supplying device 110 is further provided with four flexible tubes 116 which connect the connection units 115 to the printing head 108 (printing carriage 107) for supplying ink.

The ink supplying device 110 has a sensing device 117 for sensing the amount of ink remaining in the ink cartridge 113. It should be noted that the ink housing 114, a part of the connection units 115 and the sensing device 117 are omitted in FIG. 8 for the sake of simplicity.

As shown in FIG. 9, the ink housing 114 has a mounting base 118 on which the ink cartridge 113 is placed, a stopper plate 119 which is formed to be extended vertically at the right end of the mounting base 118 to contact the front (right side) wall of the ink cartridge 113, and an upper plate 120 extending form the top of the stopper plate 119 in a horizontal direction to support the top surface of the ink cartridge 113. The ink housing 114 is further provided with guide plates 121 (see FIG. 11) to support both of the longer side surfaces of the ink cartridge 113.

That is, the ink housing 114 has an opened section on the left side (on FIG. 9) thereof. The ink cartridge 113 is set in the ink housing 114 by inserting the ink cartridge 113 from the opened side (left side) toward the inside of the ink housing 114 as indicated by an arrow A in FIG. 9. The ink cartridge 113 can be detached from the ink housing 114 by pulling out the ink cartridge 113 in a direction opposite to the direction A (the arrow A).

The sensing device 117 includes a sensing lever 122 located above the upper plate 120, and a sensor 123. At the right end of the upper plate 120, a vertical plate 124 is formed in the center of the shorter side of the ink cartridge 114 to be elongated in the vertical direction. The sensing lever 122 is attached to the vertical plate 124 to be rotatable at the right end thereof.

The sensing lever 122 has a triangular contacting part 125. In addition, a window 126 is formed in the upper plate 120 so that the contacting part 125 can pass through the window 126. A guide groove 127 having a form of an arc is formed in the contacting part 125 so that a guide pin 129 formed on a plate 128 provided on the top surface of the upper plate 120 slides in the guide groove 127 to support the sensing lever 122. By this structure, the guide pin 129 slides in the guide groove 127 as the sensing lever 122 rotates about its right end position.

A vertical wall 130 is formed at the left end of the upper plate 120 to be extended in the vertical direction. A sensor 23 is fixed to the vertical wall 130 to detect the amount of ink remaining in an ink bag 136. The sensor 23 is constituted by, for example, a transmission type photo interrupter which detects that a sensing part 131 of the sensing lever 125 passes through a space between a light emitting device and a photoreceptor of the photo interrupter. By this structure, the amount of ink remaining in the ink bag 136 is detected.

The connection unit 115 has a hollow needle 132 which protrudes toward the inside of the ink housing 114.

The ink cartridge 113 has a case 133 having a form of a box, and the ink pack 134 accommodated in the case 133. The case 133 is formed, for example, from cardboard. The ink pack 134 includes the flexible ink bag 136 accommodating the ink, and a stopper 137 from which the ink is released. The ink bag 136 is formed by lapping a flexible transparent plastic sheet over another, and sealing off them, except a releasing portion 135, by heat at the periphery of the plastic sheets. That is, the ink bag 136 is formed to be a flat bag.

The stopper 31 is sandwiched between the two plastic films at the releasing portion 135 located at the front end (right side end in FIG. 9) of the ink bag 136.

The plastic film consisting the ink bag 136 is formed, for example, from a laminated structure of polyethylene, nylon, and PET on which silica is deposited, which are laminated in that order from the inside. For example, the polyethylene, nylon and PET may have the thicknesses of 40 μm, 15 μm and 12 μm, respectively.

For example, the ink bag 136 has an effective size of 150 mm at the longer side (i.e. a size “a” shown in FIG. 12B) of 150 mm, and 112 mm at the shorter side (i.e. a size “b” shown in FIG. 12B). For example, the sealing width (indicated by a hatching pattern in FIG. 12B) is 10 mm at the front side, and is 6 mm at the other sides. The ink bag 136 is configured to accommodate the ink of 250 g at an initial state. For example, the ink has a relative density of approximately 1.1.

The stopper 37 is formed by molded resin such as PE and PP. The stopper 37 is provided with a base part 138 having a hollow 138a, and a connection part 139 which is integrally formed with the base part to be extended from the base part toward the left side (in FIG. 9). The connection part 139 is fixed to the releasing portion 135 of the ink bag 136.

The base part 138 of the stopper 37 is provided with a rectangular block 140 at its tip portion (the right side end in FIG. 9) having a box shape. The rectangular block 140 has a cylindrical hole 140a which communicates with the hollow 138a and is sealed by a rubber stopper 41. The hollow 138a has a tapered shape of which size increases gradually toward the cylindrical hole 140a (toward the right side in FIG. 9).

In the hollow 138a, a filter 142 is located at a position near to the connection part 139. The base part 138 is provided with a positioning projection 138b at the bottom surface thereof.

The connection portion 139 has a flat shape, and has a communication hole 139a for connecting the hollow 138a to the inside of the ink bag 136. By connecting the connection part 139 of the stopper 137 to the releasing portion 135 of the ink pack 134, the hollow 138a is connected to the inside of the ink bag 136, and thereby the ink in the ink bag 136 is supplied from the ink bag 136 to the hollow 138a through the filter 142.

As shown in FIGS. 9 and 10, a strip-shaped detection plate 143 formed, for example, from cardboard is adhered to the top surface of the ink bag 136 at the center along a direction of the longer side of the ink bag 136. The detection plate 143 has a length substantially equal to the width (i.e. the length in a direction of a shorter side of the ink bag 136) of the effective size of the ink bag 136. The width of the detection plate 143 is, for example, 30 mm.

More specifically, the detection plate 143 is located on the top surface of the ink bag 136 at a region which becomes substantially horizontal when the ink bag 136 becomes nearly empty of ink. The detection plate 143 is adhered to the top surface of the ink bag 136, for example, by a double-faced tape.

The case 133 is configured such that a clearance is formed between the inner surface of the case 133 and the outer surface of the ink bag 136. The case 133 has a slit 144 at the center of the top surface thereof. In a situation in which the case 133 is set in the ink housing 114, the slit 144 lies beneath the window 126 formed in the upper plate 120. This structure allows the sensing lever 125 to be inserted into inside of the case 133 through the window 126 and the slit 144.

One of walls of the case 133 facing the stopper 137 of the ink pack 134 has a circular opening 133a at the center thereof so as to face the opening 140a of the stopper 137. A positioning hole 133b is formed in the bottom wall of the case 133 at a position under the opening 133a so that the positioning projection 138b of the stopper 137 is fitted into the positioning hole 133b.

On the inner bottom surface of the case 133, a seating plate 145 formed, for example, from cardboard is placed at the rear side (the left side in FIG. 9) of the case 133 so as to lift the entire rear end (i.e. an end portion opposed to the releasing portion 135) of the ink bag 136. The seating plate 145 is formed from a strip-shaped member having a length substantially equal to the width of the ink bag 136. For example, the length of the seating plate 145 is 30 mm.

The case 133 may be formed from a sheet of cardboard which is cut to have a certain shape and is formed to have creases and openings so that the case 133 can be formed by folding the sheet of cardboard. The case 133 is further provided with a holding member (not shown) at the front side (the right side in FIG. 9) so as to hold the stopper 137 by pressing downwardly on the top surface of the stopper 137 and pressing a portion of the rear (left) surface of the stopper 137 toward the front (right) side.

In the ink cartridge 134, the ink pack 134 is placed in the case 133 with the positioning projection 138b being fitted into the positioning hole 133b and the stopper 137 being held by the holding member. In this situation, the hole 140a of the stopper 137 faces the opening 133a of the front wall of the case 133. Also, the ink bag 136 is placed on the inner bottom surface of the case 133 with the rear end of the ink bag 136 being lifted by the seating plate 145.

In a situation in which the ink cartridge 113 is set in the ink housing 114, the contacting part 125 of the sensing lever 122 is inserted into the inside of the case 133, and the tip of the contacting part 125 constantly contacts the detection plate 143.

Next, the operation regarding the ink cartridge 113 will be explained in detail with reference to FIGS. 9 and 10.

A setting process of the ink cartridge 113 is as follows. The ink cartridge 113 is set in the ink housing 114 while the contacting part 125 of the sensing lever 122 is pulled out of the window 126 by a user. In this stage, the hollow needle 132 of the connection unit 115 penetrates the rubber stopper 141 at the center of the rubber stopper 141 through the opening 133a of the front wall of the case 133, and the tip of the hollow needle 132 reaches the hollow 138a of the stopper 137. Thus, the ink in the ink bag 136 is supplied to the printing head 108 through the stopper 137, the connection unit 115, and the tube 116.

Next, the sensing lever 122 is rotated downwardly so that the contacting part 125 is inserted into the inside of the case 133 through the window 126 and the slit 144. Thus, the tip of the contacting part 125 contacts the detection plate 143.

At the initial state of use of the ink cartridge 113, the ink bag 136 is filled with ink. For example, the 250 grams of ink is accommodated in the ink bag 136 at the initial state. The ink bag 136 is inflated by the ink, and thereby the detection plate 143 is situated at its upper end position. At this stage, the sensing lever 122 is situated at its upper end point, and the sensing part 131 of the sensing lever 122 is situated at a position away from the sensor 123 (see FIG. 9).

As the amount of ink in the ink bag 136 decreases with the execution of the printing operation, the consumed amount of ink is refilled in the printing head 108 from the ink pack 134. As the amount of ink in the ink bag 136 decreases, the ink bag 36 deflates. As a result, the detection plate 134 moves downwardly with the deflation of the ink bag 136, and the sensing lever 122 rotates downwardly.

As shown in FIG. 10, if the ink bag 136 becomes nearly empty state, the top surface of the ink bag 136 comes very close to the bottom surface of the ink bag 136. As a result, the detection plate 143 reaches its lower end position, and the sensing lever 122 also rotates to its lower end position. In this stage, the passing of the sensing part 131 of the sensing lever 122 is detected by the sensor 123. The output of the sensor 123 is sent to the control unit so that the control unit notifies the user of the replacement time of the ink cartridge 113.

The left end portion of the ink bag 136 is lifted by the seating plate 145. More specifically, the seating plate 145 is elongated in the direction of the shorter side of the ink bag 136 so as to have the length substantially equal to effective size (in the direction of the shorter side of the ink bag 136) of the ink bag 136. By this structure, the ink lying on the left side in the ink bag 136 is moved to the center of the ink bag 136 in the direction of the longer side of the ink bag 136.

The detection plate 143 is elongated in the direction of the shorter side of the ink bag 136. Therefore, the central portion of the top surface of the ink bag 136 is flattened by the detection plate 143. Also, the ink in the ink bag 136 is moved to a region nearer to the stopper 137 in the ink bag 136. By this structure, the amount of ink remaining in the ink bag 136 at the replacement time of the ink cartridge 113 can be reduced.

The left portion of the ink bag 136 is lifted by the seating plate 145, and the central portion of the ink bag 136 in the direction of the longer side of the ink bag 136 becomes the lowest of all positions of the top surface of the ink bag 136. The central portion of the ink bag 136 becomes the highest of all positions of the top surface of the ink bag 136 when the ink bag 136 is filled with the ink. Therefore, the position of the detection plate 143 changes by a large amount in the vertical direction with use of ink.

The detection plate 143 is located on the top surface of the ink bag 136 so that the detection plate 143 lies only on the portion which is flattened when the ink bag 136 becomes empty of water. In addition, the detection plate 143 is elongated across the effective size of the ink bag 136, so that the position of the detection plate 143 changes only depending on the effective area of the ink bag 136 without being affected by the sealing portion formed at the periphery of the ink bag 136. By this structure, it is possible to reliably detect that the ink bag 136 is empty of ink.

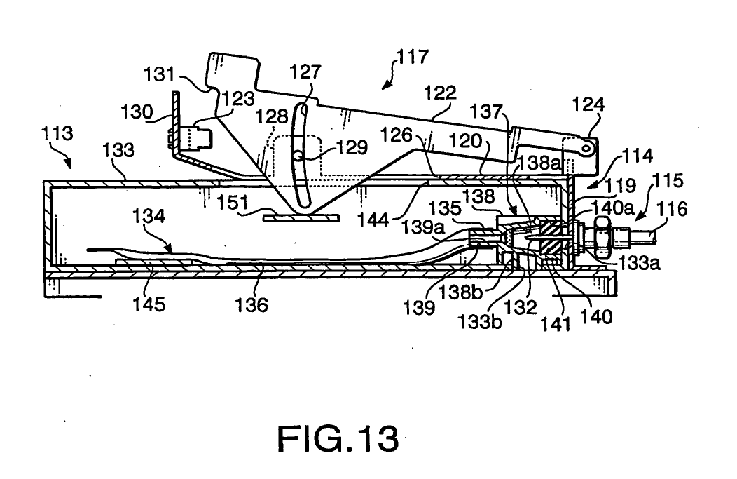

FIG. 13 shows another example of a configuration of an ink supplying unit according to the invention. Since the configuration of the ink supplying unit shown in FIG. 13 has substantially the same configuration as that shown in FIG. 10, only the feature of the configuration of this example is explained.

As shown in FIG. 13, a circular detection plate 151 is fixed to the tip of the contacting part 125 of the sensing lever 122. The detection plate 151 directly contacts the top surface of the ink bag 136 to detect the amount of ink in the ink bag 136. On the top surface of the ink bag 136, the detection plate 151 contacts the portion which is flattened (becomes a horizontal surface) when the ink bag 136 becomes empty of ink.

It should be noted that FIG. 13 illustrates a situation in which the detection plate 151 (the sensing lever 122) is at a position away from the top surface of the ink bag 136; however, in actuality, the detection plate 151 (the sensing lever 122) moves upwardly or downwardly with the movement of the top surface of the ink bag 136.

It is understood that the same advantage as that of the configuration explained with reference to FIGS. 9 and 10 can also be attained by the ink supplying device shown in FIG. 13.

Various types of variations regarding the ink cartridge 113 are possible. In the second embodiment, the amount of ink remaining in the ink bag is detected by detecting the position of the sensing lever that moves with the movement of the detection plate. However, the ink cartridge may be configured such that the detection plate attached to the top surface of the ink bag is provided with a projection which protrudes through the window formed in the top surface of the case, and that the projection of the detection plate presses a switch to notify the use of the replacement time of the ink cartridge.

A worker can know the amount of ink remaining in the ink bag by visually checking the length of the projection protruded from the window of the top surface of the case. In this case, the switch can be omitted.

In the above mentioned embodiment, the detection plate 143 is elongated across the width of the effective size of the ink bag 136. However, another detection plate having the length shorter than that of the detection plate 143 may be used.

The seating plate (145) may be attached to the bottom surface of the ink bag 136.

A gazette bag may be used as the ink bag. Also, various types of stoppers having different outer shapes and inner structures can be employed.

In the above mentioned embodiment, the case 133 is formed by a sheet of cardboard. However, various types of material (e.g. plastic) may be used to form the case 133. Also, the case 133 may have a different structure.

Although the present invention has been described in considerable detail with reference to certain preferred embodiments thereof, other embodiments are possible.

It is understood that the present invention can be also applied to various type of printing devices, such as a typical inkjet printer that prints images on a sheet, although the above mentioned embodiment particularly described the inkjet printing device for fabric. The present invention may be applied to a line printer as well as a serial printer. Also, the present invention may be applied to a bubble jet type printer.

1. An ink pack, comprising:
an ink bag that accommodates ink; and
a stopper attached to the ink bag to release the ink out of the ink bag,
wherein the ink pack is configured to satisfy a condition:
$$\frac{h}{2} \leq H < 2 h$$
where H represents a height of a releasing position, at which the ink in the ink bag is released out of the stopper, with respect to a mounting surface on which the ink bag is placed, and h represents a size of the ink bag measured in a vertical direction when the ink bag in an initial state is placed on a horizontal surface.

2. The ink pack according to claim 1, wherein a difference between values of H and h is within a range of −10 mm through +10 mm.

3. The ink pack according to claim 1, wherein the ink bag has flexibility.

4. An ink cartridge, comprising:
an ink pack that has an ink bag that accommodates ink, and a stopper attached to the ink bag to release the ink out of the ink bag; and
a case that accommodates the ink pack, the case having a mounting surface on which the ink bag is placed and a stopper holder that holds the stopper,
wherein the ink cartridge is configured to satisfy a condition:
$$\frac{h}{2} \leq H < 2 h$$
where H represents a height of a releasing position, at which the ink in the ink bag is released out of the stopper holder, with respect to the mounting surface, and h represents a size of the ink bag measured in a vertical direction when the ink bag in an initial state is placed on a horizontal surface.

5. The ink cartridge according to claim 4, wherein a difference between values of H and h is within a range of −10 mm through +10 mm.

6. The ink cartridge according to claim 4, wherein the ink bag has flexibility.

7. The ink cartridge according to claim 4, further comprising:
a seating member provided in the case to lift a second portion of the ink bag opposed to a first portion to which the stopper is attached; and
a detection member attached to a top surface of the ink bag at a portion which becomes a substantially horizontal surface when the ink bag becomes substantially empty of ink.

8. An ink supplying device, comprising:
an ink housing to which an ink pack is detachably attached, the ink pack having an ink bag accommodating ink and having a stopper attached to the ink bag; and
a connection unit that is connected to the stopper of the ink pack to release the ink out of the ink bag through the stopper,
wherein the ink supplying device is configured to satisfy a condition:
$$\frac{h}{2} \leq H < 2 h$$
where H represents a height of a releasing position, at which the ink in the ink bag is released out of the connection unit, with respect to a mounting surface on which the ink bag is placed, and h represents a size of the ink bag measured in a vertical direction when the ink bag in an initial state is placed on a horizontal surface.

9. The ink supplying device according to claim 8, wherein a difference between values of H and h is within a range of −10 mm through +10 mm.

10. An ink supplying device, comprising:
an ink housing to which an ink cartridge is detachably attached, the ink cartridge having an ink pack and a case accommodating the ink pack, the ink pack having an ink bag accommodating ink and having a stopper attached to the ink bag, and
a connection unit that is connected to the stopper of the ink pack to release the ink out of the ink bag through the stopper,
wherein the ink supplying device is configured to satisfy a condition:
$$\frac{h}{2} \leq H < 2 h$$
where H represents a height of a releasing position, at which the ink in the ink bag is released out of the connection unit, with respect to a mounting surface on which the ink bag is placed, and h represents a size of the ink bag measured in a vertical direction when the ink bag in an initial state is placed on a horizontal surface.

11. The ink supplying device according to claim 10, wherein a difference between values of H and h is within a range of −10 mm through +10 mm.

12. An ink cartridge, comprising:
an ink bag that accommodates ink;
a stopper attached to a first portion of the ink bag to release the ink out of the ink bag;
a case that accommodates the ink bag;
a seating member provided in the case to lift a second portion of the ink bag opposed to the first portion; and
a detection member attached to a top surface of the ink bag at a portion which becomes a substantially horizontal surface when the ink bag becomes substantially empty of ink.

13. The ink cartridge according to claim 12,
wherein the ink bag has a rectangular shape,
wherein the stopper is attached to one of shorter sides of the ink bag, and
wherein the seating member is located in a portion opposed to the one of the shorter sides of the ink bag with respect to a center position along a longer side of the ink bag.

14. The ink cartridge according to claim 13, wherein the seating member has a shape elongated in a direction of a shorter side of the ink bag.

15. The ink cartridge according to claim 14, wherein the seating member is elongated in the direction of the shorter side of the ink bag across an effective size of the ink bag in the direction of the shorter side.

16. The ink cartridge according to claim 13,
wherein the seating member lifts the ink bag so that the substantially horizontal surface formed when the ink bag becomes substantially empty of ink is situated on a stopper side with respect to a center position along a direction of a longer side of the ink bag, and
wherein the detection member is located on the stopper side with respect to the center position along the direction of the longer side of the ink bag.

17. The ink cartridge according to claim 12, wherein the seating member is fixed to an inner bottom surface of the case.

18. The ink cartridge according to claim 12, wherein the detection member is made from paper.

19. The ink cartridge according to claim 13, wherein the detection member has a shape elongated in a direction of a shorter side of the ink bag.

20. The ink cartridge according to claim 19, wherein the detection member is elongated in the direction of the shorter side of the ink bag across an effective size of the ink bag in the direction of the shorter side.

21. The ink cartridge according to claim 12,
wherein the case having a mounting surface on which the ink bag is placed and a stopper holder that holds the stopper, and
wherein the ink cartridge is configured to satisfy a condition:
$$\frac{h}{2} \leq H < 2 h$$
where H represents a height of a releasing position, at which the ink in the ink bag is released out of the stopper holder, with respect to the mounting surface, and h represents a size of the ink bag measured in a vertical direction when the ink bag in an initial state is placed on a horizontal surface.

22. A sensing system for sensing a remaining amount of ink, comprising:
an ink bag that accommodates ink;
a stopper attached to a first portion of the ink bag to release the ink out of the ink bag;
a case that accommodates the ink bag;
a housing in which the case is set;
a seating member provided in the case to lift a second portion of the ink bag opposed to the first portion; and
a sensing member that is movably attached to the housing and has a plate-like member, the plate-like member contacting a top surface of the ink bag at a portion which becomes a substantially horizontal surface when the ink bag becomes substantially empty of ink.

23. A sensing system for sensing a remaining amount of ink, comprising:
an ink bag that accommodates ink;
a stopper attached to a first portion of the ink bag to release the ink out of the ink bag;
a case that accommodates the ink bag;
a housing in which the case is set;
a seating member provided in the case to lift a second portion of the ink bag opposed to the first portion;
a detection member attached to a top surface of the ink bag at a portion which becomes a substantially horizontal surface when the ink bag becomes substantially empty of ink; and
a sensing member that is movably attached to the housing so that a tip portion of the sensing member contacts the detection member.
